(19) United States
(12) Patent Application Publication
(10) Pub. No.: US 2013/0222285 A1
(43) Pub. Date: Aug. 29, 2013

(54) MOBILE TERMINAL AND METHOD FOR OPERATING BASED ON A TOUCH INPUT

(71) Applicant: PANTECH CO., LTD., (US)

(72) Inventors: Yeon-Mee LEE, Gunpo-si (KR); Sang-Woo SHIN, Goyang-si (KR)

(73) Assignee: PANTECH CO., LTD., Seoul (KR)

(21) Appl. No.: 13/705,927

(22) Filed: Dec. 5, 2012

(30) Foreign Application Priority Data
Feb. 23, 2012 (KR) 10-2012-0018505

(51) Int. Cl. G06F 3/01

(52) U.S. Cl. CPC G06F 3/017
USPC 345/173

(57) ABSTRACT

A mobile terminal to control an operation using a touch includes a first input area to detect a first touch input, a second input area to detect a touch gesture, and a touch sensing unit to detect whether to activate the second input area based on the first touch input, to determine a state of the mobile terminal, and to determine a control operation corresponding to the touch gesture with respect to the state of the mobile terminal, in which at least one of the first input area and the second input area is disposed on a side of a body of the mobile terminal.

### CROSS-REFERENCE TO RELATED APPLICATION

This application claims priority and the benefit under 35 U.S.C. §119(a) of Korean Patent Application No. 10-2012-0018505, filed on Feb. 23, 2012, the entire disclosure of which is incorporated herein by reference for all purposes.

### BACKGROUND

1. Field

The following description relates to a mobile terminal and a method for performing an operation based on a touch input.

2. Discussion of the Background

In order to power on a general mobile terminal, a user may use a power key disposed on the outer surface of the mobile terminal. Generally, the power key may be a tact switch or a dome switch mounted on a Flexible Printed Circuit Board (FPCB). If the user presses the power key to supply power to the mobile terminal, the power key may operate as an event input key to execute an End/Hold operation or a similar operation of the mobile terminal.

The mobile terminal may also provide volume keys separately installed on the outer surface of the mobile terminal. The volume keys may be provided by tact switches, dome switches, jog keys, and the like. As such, the power key and volume keys may be configured as mechanical switches, which may manipulated to transmit an event, such as power on/off, hold, and volume up/down, to the Central Processing Unit (CPU) of the mobile terminal. Accordingly, the event corresponding to the user input may be executed through the power key and volume keys. However, such mechanical switches may have some instrumental and design limitations in the amount of operations they may provide. Furthermore, the mechanical switches may be subject to faster deterioration in reliability due, in part, to their frequency in use.

### SUMMARY

Exemplary embodiments of the present invention provide a mobile terminal and a method for performing an operation based on a touch input.

Additional features of the invention will be set forth in the description which follows, and in part will be apparent from the description, or may be learned by practice of the invention.

Exemplary embodiments of the present invention provide a method for controlling an operation of a mobile terminal using a touch including detecting a first touch input in a first input area, determining whether to activate a second input area based on the first touch input, detecting a touch gesture in the second input area if the second input area is activated, determining a state of the mobile terminal, and determining a control operation corresponding to the touch gesture with respect to the state of the mobile terminal, in which at least one of the first input area and the second input area is disposed at a side of a body of the mobile terminal.

Exemplary embodiments of the present invention provide a mobile terminal to control an operation using a touch including a first input area to detect a first touch input, a second input area to detect a touch gesture, and a touch sensing unit to detect whether to activate the second input area based on the first touch input, to determine a state of the mobile terminal, and to determine a control operation corresponding to the touch gesture with respect to the state of the mobile terminal, in which at least one of the first input area and the second input area is disposed on a side of a body of the mobile terminal.

Exemplary embodiments of the present invention provide a method for controlling an operation of a mobile terminal using a touch including detecting a touch gesture in an input area disposed at a side of a body of the mobile terminal, determining a state of the mobile terminal, and determining a control operation corresponding to the touch gesture with respect to the state of the mobile terminal.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, is illustrate embodiments of the invention, and together with the description serve to explain the principles of the invention.

FIG. 1 is a diagram illustrating a configuration of a mobile terminal according to an exemplary embodiment of the present invention.

FIG. 2 is a diagram illustrating a touch sensing unit of a mobile terminal according to an exemplary embodiment of the present invention.

FIG. 3 illustrates using a power control operation and a hold control operation using a touch input according to an exemplary embodiment of the present invention.

FIG. 4 is a timing diagram illustrating a signal pulse of the touch sensing unit corresponding to a power control operation using a touch input according to an exemplary embodiment of the present invention.

FIG. 5 is a timing diagram illustrating a signal pulse of the touch sensing unit according to an exemplary embodiment of the present invention.

FIG. 6 illustrates performing a volume control operation using a touch input according to an exemplary embodiment of the present invention.

FIG. 7 illustrates performing a volume control operation using a touch input according to an exemplary embodiment of the present invention.

FIG. 8 is a timing diagram illustrating a user interrupt signal pulse of the touch to sensing unit in response to manipulation of a volume short key and a volume long key according to an exemplary embodiment of the present invention.

FIG. 9 illustrates a state model of a mobile terminal according to an exemplary embodiment of the present invention.

FIG. 10 is a flowchart illustrating a method for performing a power control operation according to an exemplary embodiment of the present invention.

FIG. 11 is a diagram illustrating a configuration of a mobile terminal according to an exemplary embodiment of the present invention.

FIG. 12 is a diagram illustrating a configuration of a mobile terminal according to an exemplary embodiment of the present invention.

FIG. 13 is a flowchart illustrating a method for performing a power control operation according to an exemplary embodiment of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

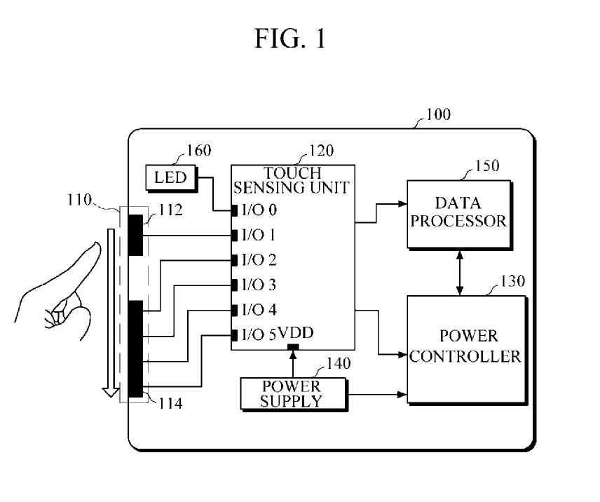

FIG. 1 is a diagram illustrating a configuration of a mobile terminal 100 according to an exemplary embodiment of the present invention.

Referring to FIG. 1, the mobile terminal 100 includes a touch panel 110, a touch sensing unit 120, a power controller 130, a power supply 140, a data processor 150, and a light emitting diode (LED) 160. The mobile terminal 100 may be, without limitation, a mobile phone, a Motion Picture Experts Group Audio Layer III (MP3) player, a smart phone, a personal computer, and the like. The mobile terminal 100 may further include a touch screen that may receive a user input to control a power operation and may display execution results of the power operation according to the user input. The mobile terminal 100 may also include various communication modules, a Global Positioning System (GPS) receiver, a memory, and the like. The touch panel 110 may provide a touch-based switch module, instead of a conventional mechanical structure of a switch module configured with a power key, a hold key, and volume keys.

The touch panel 110 may be installed separately from a general touch screen that may be used to control operations of various applications of the mobile terminal 100, and may operate independently from the touch screen. The touch panel 110 may be activated or deactivated under a control of the touch sensing unit 120. The touch panel 110 includes a first input area 112 and a second input area 114. The touch panel 110 may receive a touch input or gesture in the first input area 112 and/or the second input area 114 to generate a touch signal corresponding to the touch input or gesture. In an example, at least one of the first input area 112 and the second input area 114 may be a touch input area. The touch gesture may refer to touch motion, such as a touch and drag motion or a touch and flick motion, but is not limited thereto.

The first input area 112 may include at least one touch sensor that may receive one or more touch inputs, and the second input area 114 may include a plurality of touch sensors that may receive a plurality of touch inputs. The touch sensors included in the first input area 112 and the second input area 114 may include various types of touch sensors, such as capacitive touch sensors, resistive touch sensors, and pressure sensors.

The first input area 112 and the second input area 114 may be configured on the same Flexible Printed Circuit Board (FPCB) or on separate FPCBs. FIG. 1 shows the case where the first input area 112 and the second input area 114 are disposed on the left side of a body of the mobile terminal 100. However, aspects of the invention are not limited thereto. For example, the first input area 112 may be disposed on an upper portion of the mobile terminal 100, and the second input area 114 may be disposed on side portions (e.g., left/right portions) of the body of the mobile terminal 100. Further, the first input area 112 may be disposed on the side portions (e.g., left/right portions) of the body of the mobile terminal 100, and the second input area 114 may be disposed on a rear side portion of the body of the mobile terminal 100.

If a touch input of a user is sensed or detected in the first input area 112, the mobile terminal 100 may perform a power control operation, such as powering on or powering off the mobile terminal 100 or a component of mobile terminal 100. However, the mobile terminal 100 may perform another operation, such as a mode conversion operation (e.g., conversion to a hold on mode). Further, if a touch input of a user is sensed or detected in the second input area 114, the mobile terminal 100 may perform a volume control operation. However, aspects of the invention are not limited thereto, such that the mobile terminal 100 may perform other control operations as well, such as turning a page, opening an e-mail, and the like, according to an application execution state of the mobile terminal 100.

Also, if the touch input of the user is sensed in the first input area 112 and the second input area 114, a touch signal may be generated and transferred to the touch sensing unit 120.

The touch sensing unit 120 is connected to the power supply 140, which may supply electric current to at least a part of the touch panel 110 to activate (or deactivate) the one or more parts of the touch panel 110. Accordingly, the touch sensing unit 120 may control the power control operation of the touch panel 110. The touch sensing unit 120 may receive a touch signal generated according to a touch input or gesture sensed or detected by touching the touch panel 110, generate a control signal in response to the touch signal, and transfer the control signals to the power controller 130 and the data processor 150, respectively. The control signal transferred from the touch sensing unit 120 to the power controller 130 may be referred to as a power control signal, and the control signal transferred from the touch sensing unit 120 to the data processor 150 may be referred to as a user input interrupt signal.

The touch sensing unit 120 may include a plurality of input/output (I/O) ports, including an I/O port 0, an I/O port 1, an I/O port 2, an I/O port 3, an I/O port 4, and an I/O port 5 to receive a plurality of touch signals. As shown in FIG. 1, the I/O port 1 is connected to the first input area 112, and the remaining I/O ports, including the I/O port 2, the I/O port 3, the I/O port 4, and the I/O port 5 are connected to the second input area 114. The I/O port 0 is connected to the LED 160. If the first input area 112 includes a plurality of touch sensors, the touch sensing unit 120 may include a plurality of I/O ports that may be connected to the plurality of touch sensors of the first input area 112.

The touch sensing unit 120 may generate a power control signal according to a state of the mobile terminal 100 or according to a touch signal, and may provide the power control signal to the power controller 130. Further, the touch signal may be generated in response to a sensed touch gesture. The power control signal is also referred to as a PWR signal. Also, if a user input interrupt signal is transferred to the data processor 150 according to a touch signal, the touch sensing unit 120 may perform data reception/transmission with the data processor 150 through a database such as I²C.

The power controller 130 may control the power supply 140 to provide power to one or more operational modules including the data processor 150 of the mobile terminal 100. The power controller 130 may start or stop providing power to the mobile terminal 100, or control power that may be provided to the mobile terminal 100, according to a power control signal.

The power control signal transferred from the touch sensing unit 120 to the power controller 130 may have various types of waveforms according to a state of the mobile terminal 100, or according to a touch signal. The power control signal may include at least one of a power supply start control signal to enable the power controller 130 to power on the mobile terminal 100, a power supply stop control signal to enable the power controller 130 to power off the mobile terminal 100, a hold on control signal to enable the power controller 130 to convert the mobile terminal 100 to a hold state where one or more components of the mobile terminal 100 may not be operational, and a hold off control signal to enable the power controller 130 to return the mobile terminal to the power on state. The power controller 130 may supply, when receiving a power supply start control signal, power to the mobile terminal 100 to perform a power control operation in an active mode in which the mobile terminal 100 operates normally. The power controller 130 may stop the supply of power to the mobile terminal 100 when a power supply stop control signal is received. Also, the power controller 130 may convert the mobile terminal 100 to a hold state, which may prevent power from being supplied to one or more modules or components of the mobile terminal 100 (e.g., a touch screen) so that that the respective module or components do not operate. Also, when receiving a hold off control signal, the power controller 130 may perform power control operation in the active mode in which the mobile terminal operates normally.

If a touch signal is generated when the mobile terminal 100 is in a power off state, a power supply start control signal may be generated. Further, if a touch signal is generated when the mobile terminal 100 is in a power on state, a user input interrupt signal may be generated and transferred to the data processor 150.

The data processor 150 may run an application for operating the mobile terminal 100. More specifically, if the power controller 130 receives a power supply start control signal, the data processor 150 may receive power from the power controller 130 to operate the mobile terminal 100.

If the mobile terminal 100 is powered off, the touch sensing unit 120 may activate the first input area 112, and may deactivate the second input area 114 to reduce power consumption when the mobile terminal 100 is in the power off state. If a touch signal is generated by sensing a touch input in the first input area 112 that is maintained for a duration longer than a first reference time period, the touch sensing unit 120 may activate the second input area 114. If a touch signal corresponding to a touch and drag input the second input area 114 is sensed or detected, the touch sensing unit 120 may generate a power supply start control signal to supply power to the mobile terminal 100.

Further, the touch sensing unit 120 may supply power to the LED 160 to emit a light, which may visually inform the user that the second input area 114 has been activated. The LED 160 may be included in the mobile terminal 100, and different types of light-emitting device may be used. However, aspects of the invention are not limited thereto, such that an audio output device or a vibrating device may be used instead of the LED 160 to inform the user of the activation of the second input area 114.

Further, if a touch input or gesture is sensed or detected in the second input area 114 when the mobile terminal 100 is in the power on state, the touch sensing unit 120 may transfer a user input interrupt signal corresponding to the touch input to the data processor 150. The data processor 150 may control an operation of an application executed in the terminal 100 according to the user input interrupt signal.

The power supply 140 may be a fixed battery or a removable battery, and may be configured to be charged using an external power supply. However, aspects of the invention are not limited thereto, such that the power supply 140 may be an alternating current (AC) adapter.

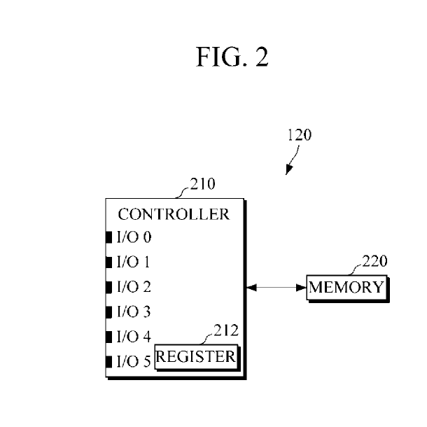

FIG. 2 is a diagram illustrating the touch sensing unit 120 of the mobile terminal 100 according to an exemplary embodiment of the present invention.

Referring to FIG. 2, the touch sensing unit 120 may include a controller 210 and a memory 220. The controller 210 may perform an operation of the touch sensing unit 120 based on data stored in the memory 220. The controller 210 may run an algorithm to recognize a touch input or a touch gesture that may be detected or sensed on the touch panel 110.

Referring to FIG. 1 and FIG. 2, the controller 210 may activate or deactivate the I/O port 0, the I/O port 1, the I/O port 2, the I/O port 3, the I/O port 4, and the I/O 5 to control the touch panel 110. If the controller 210 receives a plurality of touch sensed signals when the mobile terminal 100 is powered off or in the power off state, the controller 210 may generate a power supply start control signal to supply power to the mobile terminal 100. If the controller 210 receives a plurality of touch sensed signals when the mobile terminal 100 is powered on or in the power on state, the controller 210 may generate a user input interrupt signal and may transfer the user interrupt signal to the data processor 150.

The controller 210 may include a register 212, which may be accessed by the data processor 150. The register 212 may include a first address corresponding to state information indicating an operation mode of the mobile terminal 100. When the mobile terminal 100 enters one or more operation modes, the data processor 150 may provide state information indicating the corresponding operation mode as a first register value in the first address of the register 212. The controller 210 may deactivate a part of the touch panel 110 or change a scanning time interval for sensing or detecting a touch input on the touch panel 110, according to the first register value written in the register 212.

The controller 210 may provide input or gesture state information, which may indicate a touch input or gesture on the touch panel 110, as a second register value in a second address of the register 212. According to aspects of the invention, the controller 210 may recognize a touch input or gesture in the second input area 114, and provide a second register value indicating a drag direction in the second address of the register 212. If the data processor 150 receives a user input interrupt signal, the data processor 150 may access the second address of the register 212 to read a second register value corresponding to gesture state information, and may control the operation of an application according to a touch input or gesture based on the user input interrupt signal and the gesture state information.

The second register value may refer to information for identifying a touch input or gesture corresponding to a volume control operation, such as a volume up operation and a volume down operation. In an example, the first gesture information may correspond to the volume up operation and second gesture information may correspond to the volume down operation. The user input interrupt signal may include information associated with a time period for which a drag input or gesture on the second input area 114 is maintained after the initial touch input.

Also, if the controller 210 senses a touch input and determines that the touch input satisfies at least one wrong operation condition or fails to meet at least one of the operation conditions, the controller 210 may ignore the touch input. If the controller 210 determines that the touch input satisfies no wrong operation condition or that the touch input satisfied all of the operation conditions, the controller 210 may generate a power control signal corresponding to the touch input, transfer the power control signal to the power controller 130, and transfer a user input interrupt signal according to the touch input to the data processor 150. A wrong operation condition may be set for one or more predetermined touch inputs or gestures that can be recognized according to the state of the mobile terminal 100.

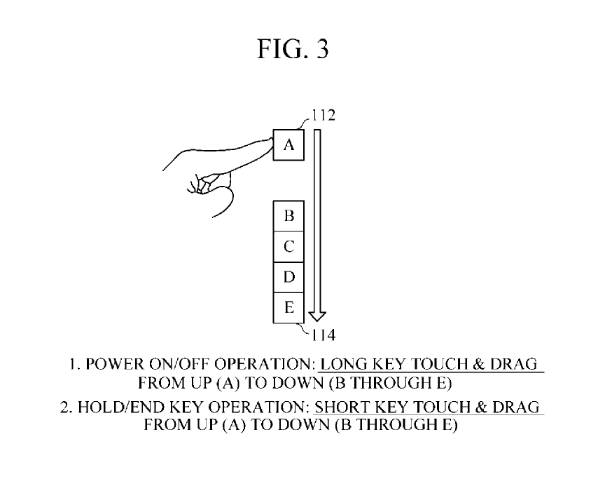

FIG. 3 illustrates using a power control operation and a hold control operation using a touch input according to an exemplary embodiment of the present invention.

As described above, referring to FIG. 1 and FIG. 3, the touch panel 110 includes the first input area 112 and the second input area 114. The first input area 112 includes a single touch sensor A, and the second input area 114 includes a plurality of touch sensors, including a touch sensor B, a touch sensor C, a touch sensor D, and a touch sensor E. The touch sensors B, the touch sensor C, the touch sensor D, and the touch sensor E of the second input area 114 may be arranged in a line to sense a touch input corresponding to a drag gesture or motion. The arrangement direction of the touch sensor B, the touch sensor C, the touch sensor D, and the touch sensor E may be a vertical direction as shown in FIG. 3, or a horizontal or a diagonal direction.

A touch input corresponding to a power on/off gesture or motion with respect to the mobile terminal 100 may be a touch input providing a sequential dragging gesture or motion on the touch sensor B, the touch sensor C, the touch sensor D, and the touch sensor E of the second input area 114 after the initial touch input sensed on the touch sensor A for a time period longer than a first reference time period. Such touch input may be referred to as a “Long Key Touch & Drag” touch input or gesture.

In more detail, when the mobile terminal 100 is in the power off state, the touch sensor A may be activated while the remaining other touch sensors, including the touch sensor B, the touch sensor C, the touch sensor D, and the touch sensor E may be inactive. If the touch sensor A senses a touch input being maintained on the first input area 112 longer than the first reference time period, the touch sensor B, the touch sensor C, the touch sensor D, and the touch sensor E of the second input area 114 may be activated. Further, the mobile terminal 100 may turn on the LED 160 to inform a user that the second input area 114 has been activated. Then, if the touch sensor B, the touch sensor C, the touch sensor D, and the touch sensor E sense a touch in a dragging motion, power may be supplied to one or more individual operation modules of the mobile terminal 100 so that the mobile terminal 100 may be powered on. If a “Long Key Touch & Drag” type of touch input or gesture is sensed when the mobile terminal 100 is in the power on state, the mobile terminal 100 may be powered off. However, aspects of the invention are not limited thereto, such that at least one of the touch sensor B, touch sensor C, touch sensor D, and touch sensor E may receive a touch input different than a dragging motion. For example, the respective touch sensors may sense a touch within a predetermined period of time after touch sensor initially senses a touch input. Further, various modules may be powered on by operating select touch sensors within the touch sensor B, touch sensor C, touch sensor D, and touch sensor E. Accordingly, various control operations may be performed by providing a touch input on various combinations of touch sensors.

The touch sensing unit 120 may determine whether one or more wrong or faulty operation conditions for the “Long Key Touch & Drag” type of touch input is satisfied, in order to detect a wrong or faulty operation related to the received touch input. For example, a first wrong operation condition for a “Long Key Touch & Drag” type of touch input may be a condition in which touch signals corresponding to the touch sensor C, the touch sensor D, and touch sensor E are generated when a touch input is provided on the touch sensor A. A second wrong operation condition may be a condition in which touch signals corresponding to the touch sensor A, touch sensor B, and the touch sensor C when a touch input is provided on the touch sensor E. A third wrong operation condition may refer to a condition in which touch inputs are simultaneously sensed by three or more touch sensors. If a “Long Key Touch & Drag” type of touch input or gesture is recognized, the touch sensing unit 120 may determines whether the “Long Key Touch & Drag” type of touch input or gesture satisfies at least one of the first wrong operation condition, the second wrong operation condition, and the third wrong operation condition. If the “Long Key Touch & Drag” type of touch input or gesture satisfies none of the first wrong operation condition, the second wrong operation condition, and the third wrong operation condition, the touch sensing unit 120 may generate a power control signal and a user input interrupt signal in response to the “Long Key Touch & Drag” type of touch input or gesture. If the “Long Key Touch & Drag” type of touch input or gesture satisfies at least one of the first wrong operation condition, the second wrong operation condition, and the third wrong operation condition, the touch sensing unit 120 may ignore the received or sensed “Long Key Touch & Drag” type of touch input or gesture.

A touch input corresponding to a hold on/off gesture or motion with respect to the mobile terminal 100 may be a touch input providing a sequential dragging gesture or motion on the touch sensor B, the touch sensor C, the touch sensor D and the touch sensor E of the second input area 114 after the initial touch input sensed on the touch sensor A for a time period shorter than the first reference time period. Such touch input may be referred to as a “Short Key Touch & Drag” touch input or gesture.

If a “Short Key Touch & Drag” type of touch input or gesture is sensed when the mobile terminal 100 is in the power on state, the mobile terminal 100 may enter a hold on state in which no touch input provided on the touch screen of the mobile terminal 100 is processed. If a “Short Key Touch & Drag” type of touch input or gesture is recognized when the mobile terminal 100 is in the hold on state, the mobile terminal may enter a hold off state or an active state in which the mobile terminal 100 may operate normally.

The touch sensing unit 120 may determine whether a touch input satisfies predetermined wrong operation conditions for the “Short Key Touch & Drag” type of touch input or gesture to detect one or more wrong operation related to the received “Short Key Touch & Drag” type of touch input or gesture. The wrong operation conditions for the “Short Key Touch & Drag” type of touch input or gesture may be similar or the same as the wrong operation conditions for the “Long Key Touch & Drag” type of touch input or gesture as described above. However, aspects of the invention are not limited thereto, such that other types of touch inputs or gestures may be recognized to provide other operations. Further, other wrong operation conditions may be provided with respect to the touch input types described above.

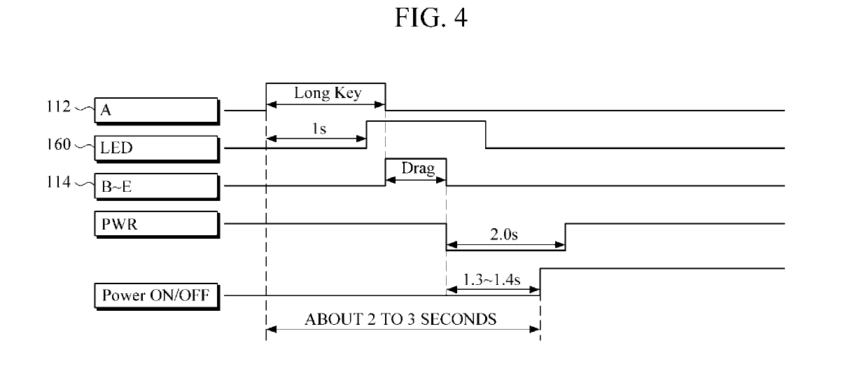

FIG. 4 is a timing diagram illustrating a signal pulse of the touch sensing unit 120 corresponding to a power control operation using a touch input according to an exemplary embodiment of the present invention.

Referring to FIG. 1 and FIG. 4, if the first input area 112 receives or senses a touch input that is maintained thereon for a duration longer than a first time period (e.g., one second), the touch sensor A may determine that the touch input sensed on the first input area 112 is a long key input when the mobile terminal 100 is in the power off state, and the touch sensing unit 120 may turn on the LED 160 to inform a user that a long key has been received at the first input area 112. Further, if the touch sensor B, the touch sensor C, the touch sensor D, and the touch sensor E of the second input area 114 are activated and a touch and drag touch input or gesture is sensed by the touch sensor B, the touch sensor C, the touch sensor D, and the touch sensor E, the touch sensing unit 120 may supply a power supply start control signal as a power control signal PWR to the power controller 130 to power on the mobile terminal 100. The power control signal PWR may have a first waveform having a signal fluctuation of about 2 seconds, as shown in FIG. 4.

If a “Long Key Touch & Drag” type of touch input or gesture is sensed when the mobile terminal 100 is in the power on state, the touch sensing unit 120 may provide a power supply stop control signal to the power controller 130 so that the mobile terminal 100 is powered off. The power supply stop control signal may have a similar or the same waveform as the power supply start control signal.

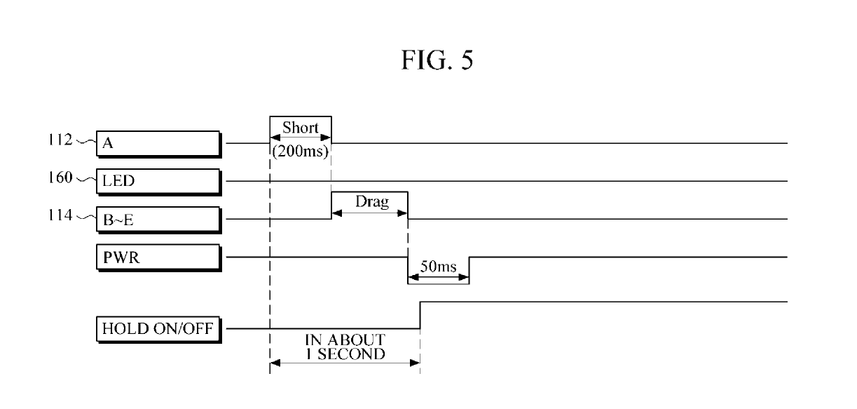

FIG. 5 is a timing diagram illustrating a signal pulse of the touch sensing unit 120 according to an exemplary embodiment of the present invention.

Referring to FIG. 1 and FIG. 5, when the mobile terminal 100 is in the power on state, if the first input area 112 receives or senses a touch input that is maintained thereon for a time duration shorter than the first time period (e.g., one second), such as 200 milliseconds (ms), the touch sensor A may determine that the touch input sensed on the first input area is a short key input. Further, if a touch and drag touch input or gesture is sensed by the touch sensor B, the touch sensor C, the touch sensor D, and the touch sensor E of the second input area 114, the touch sensing unit 120 may supply a hold on control signal as a power control signal PWR to the power controller 130 so that the mobile terminal 100 may enter a hold on state. The hold on state may prevent power from being supplied to some operational parts of the mobile terminal 100, or supply adjusted or reduced power to the operational parts of the mobile terminal 100. Accordingly, some or all of the operational parts of the mobile terminal 100 may be deactivated or operating on adjusted power supply. The hold on control signal may have a second waveform having signal fluctuation for about 50 ms, as shown in FIG. 5.

If a “Short Key Touch & Drag” type of touch input or gesture is sensed when the mobile terminal 100 is in the hold on state, the touch sensing unit 120 may provide a hold off control signal to the power controller 130 so that the mobile terminal 100 is transitioned to a hold off state. The hold off control signal may have the same waveform as the hold on control signal.

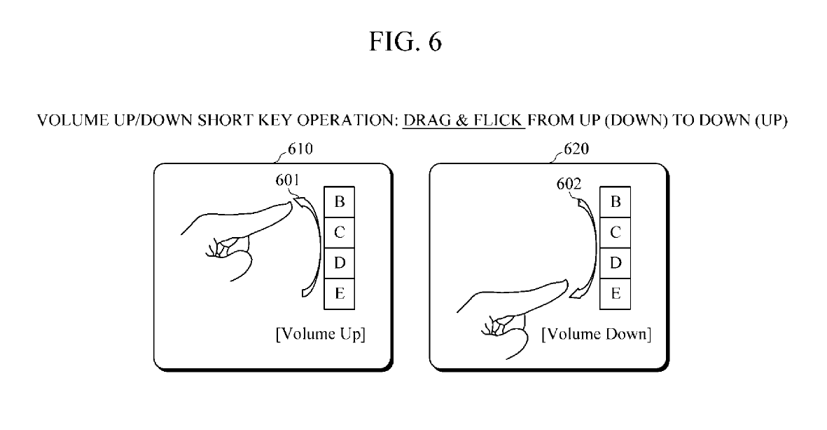

FIG. 6 illustrates performing a volume control operation using a touch input according to an exemplary embodiment of the present invention. The following description will be given with reference to FIG. 1 and FIG. 6.

When the mobile terminal 100 is in the power on state, a touch input or gesture corresponding to a touch and drag motion that may be sensed by the touch sensor B, the touch sensor C, the touch sensor D, and the touch sensor E of the second input area 114 may be classified according to a measured time period. The measured time period may refer to a duration of time, beginning from when a touch input may be initially sensed by the touch sensor to begin a drag motion or gesture until the drag motion or gesture is terminated. Further, touch input may be classified according to a direction of the drag motion or gesture. The time period may refer to a time period for which a change in capacitance may be maintained if a capacitive touch sensor is used. The time period for which the touch input is initially sensed by the touch sensor to perform a drag motion or gesture until the drag motion or gesture is terminated may be used as a dragging time by the data processor 150. However, aspects of the invention are not limited thereto, such that time may be measured using different mechanisms.

If a measured dragging time is determined to be shorter than a second time period, the corresponding touch and drag motion or gesture may be classified as a volume short key gesture. If a measured dragging time is determined to be longer than the second time period, the corresponding touch and drag motion or gesture may be classified as a volume long key gesture. Further, when the touch sensor B, the touch sensor C, the touch sensor D, and the touch sensor E are aligned vertically in this order, and a drag motion or gesture is detected from a bottom portion of the respective touch sensors to an upper portion of the respective touch sensors (i.e., the direction from the touch sensor E to the touch sensor B) is sensed, the drag motion or gesture may be classified into a volume up key gesture. Further, if a drag gesture from an upper portion of the respective touch sensors to a bottom portion of the respective touch sensors (i.e., the direction from the touch sensor B to the touch sensor E) is sensed, the drag motion or gesture may be classified into a volume down key gesture.

In addition, a volume up/down short key gesture may refer to a “Drag & Flick” gesture, and a volume up/down long key gesture may refer to a “Drag & Stop” gesture may be further described below.

Referring to the left part 610 of FIG. 6, if a “Drag & Flick” gesture 601 corresponding to a touch and drag motion provided on the touch sensor B, the touch sensor C, the touch sensor D, and the touch sensor E of the second input area 114 is in an up direction from a bottom portion of the respective touch sensors (i.e., the direction from the touch sensor E to the touch sensor B) is sensed, the touch sensing unit 120 may transfer a user input interrupt signal corresponding to the “Drag & Flick” gesture 601 to the data processor 150. The data processor 150 may control an application being executed according to the user input interrupt signal. In more detail, if a “Drag & Flick” gesture is sensed, the data processor 120 may perform at least one of volume control and a page turning operation according to a type of application that may be executed. The “Drag & Flick” gesture 601 may be referred to as a volume up short key gesture.

For example, when an audio play application is being executed, the data processor 150 may perform a volume up operation if a “Drag & Flick” gesture, such as “Drag & Flick” gesture 601 of FIG. 6, is sensed. If the “Drag & Flick” gesture, such as “Drag & Flick” gesture 601 of FIG. 6, is sensed when the data processor 150 provides a web page or a page of an electronic book, the data processor 150 may perform a page turning operation in a direction to the previous page. More specifically, the “Drag & Flick” gesture input may result in various operations based on a type of application that may be executed by the data processor 150.

The touch sensing unit 120 may determine whether a sensed touch input satisfies predetermined wrong operation conditions corresponding to a volume up short key gesture in order to detect a wrong operation related to the sensed touch input. A first wrong operation condition for the volume up short key gesture may be a condition in which at least one of the touch sensor A, the touch sensor B, and the touch sensor C generates a touch signal when the touch sensor E receives a touch input. A second wrong operation condition may be a condition in which the touch sensor A generates a touch signal when the touch sensor C and the touch sensor D simultaneously receive a touch input. A third wrong operation condition may be a condition in which three or more touch sensors simultaneously receives a touch input.

Referring to the right part 620 of FIG. 6, if a “Drag & Flick” gesture 602 corresponding to a touch and drag motion provided on the touch sensor B, the touch sensor C, the touch sensor D, and the touch sensor E of the second input area 114 is in a down direction from an upper portion of the respective touch sensors (i.e., in the direction from the touch sensor B to the touch sensor E) is sensed, the touch sensing unit 120 may transfer a user input interrupt signal corresponding to the “Drag & Flick” gesture 602 to the data processor 150. The data processor 150 may control an application being executed according to the user input interrupt signal. The “Drag & Flick” gesture 602 may be referred to as a volume down short key gesture.

For example, when an audio play application is being executed, the data processor 150 may perform a volume down operation if a “Drag & Flick” gesture, such as “Drag & Flick” gesture 602 of FIG. 6, is sensed. If the “Drag & Flick” gesture, such as “Drag & Flick” gesture 602 of FIG. 6, is sensed when the data processor 150 provides a web page or a page of an electronic book, the data processor 150 may perform a page turning operation in a direction to the next page.

A first wrong operation condition for the volume down short key gesture may be a condition in which at least one of the touch sensor D and the touch sensor E generates a touch signal when the touch sensor B receives a touch input. A second wrong operation condition may be a condition in which only the touch sensor B generates a touch signal when the touch sensor B and the touch sensor C simultaneously receives a touch input. A third wrong operation condition may be a condition in which three or more touch sensors simultaneously receives a touch input.

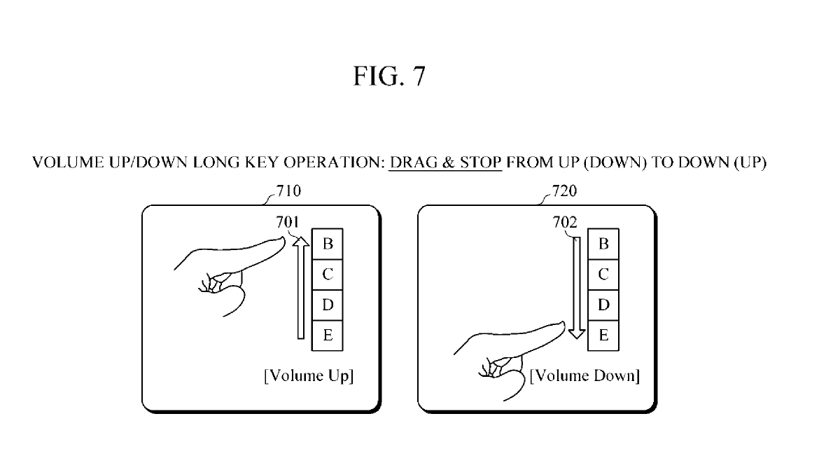

FIG. 7 illustrates performing a volume control operation using a touch input according to an exemplary embodiment of the present invention. The following description will be given with reference to FIG. 1, FIG. 2, FIG. 3, FIG. 4, FIG. 5, FIG. 6, and FIG. 7.

Referring to the right part 710 of FIG. 7, if a “Drag & Stop” gesture 701 corresponding to a touch and drag motion provided on the touch sensor B, the touch sensor C, the touch sensor D, and the touch sensor E of the second input area 114 is in an up direction from a bottom portion of the respective touch sensors (i.e., the direction from the touch sensor E to the touch sensor B) is sensed, the touch sensing unit 120 may transfer a user input interrupt signal corresponding to the “Drag & Stop” gesture 701 to the data processor 150.

The “Drag & Stop” gesture may refer to a touch input is maintained longer than a predetermined period of time at a location where the drag gesture is terminated. A change in capacitance of the touch sensor at the location where the drag gesture is terminated may be sensed for a longer period than a predetermined period of time. If a “Drag & Stop” gesture is sensed, the data processor 150 may perform at least one of volume control and a page turning operation at a higher speed than when normal operation. The “Drag & Stop” gesture 701 may be referred to as a volume up long key gesture. However, aspects of the invention are not limited thereto, such that “Drag & Stop” gesture may be used to perform other operations, for example, opening an application or file. Further, the speed of operation may be based on a type of application that may be operated at the time such gesture is sensed.

For example, when an audio play application is being executed, the data processor 150 may perform a volume up operation at a higher speed if a “Drag & Stop” gesture, such as “Drag & Stop” gesture 701 of FIG. 7, is sensed. If the “Drag & Stop” gesture, such as “Drag & Stop” gesture 701 of FIG. 7, is sensed when the data processor 150 provides a web page or a page of an electronic book, the data processor 150 may perform a page turning operation in a direction to the previous page at a higher speed. More specifically, the “Drag & Stop” gesture input may result in various operations based on a type of application that may be executed by the data processor 150.

Referring to the right part 720 of FIG. 7, if a “Drag & Stop” gesture 702 of corresponding to a touch and drag motion provided on the touch sensor B, the touch sensor C, the touch sensor D, and the touch sensor E of the second input area 114 is in a down direction from an upper portion of the respective touch sensors (i.e., in the direction from the touch sensor B to the touch sensor E) is sensed, the touch sensing unit 120 may transfer a user input interrupt signal corresponding to the “Drag & Stop” gesture 702 to the data processor 150. The data processor 150 may control an application being executed according to the user input interrupt signal. The “Drag & Stop” gesture 702 may be referred to as a volume down long key gesture.

For example, when an audio play application is being executed, the data processor 150 may perform a volume down operation at a higher speed if a “Drag & Stop” gesture, such as the “Drag & Stop” gesture 702 of FIG. 7, is sensed. If the “Drag & Stop” gesture, such as the “Drag & Stop” gesture 702 of FIG. 7, is sensed when the data processor 150 provides a web page or a page of an electronic book, the data processor 150 may perform a page turning operation in a direction to the next page at a higher speed.

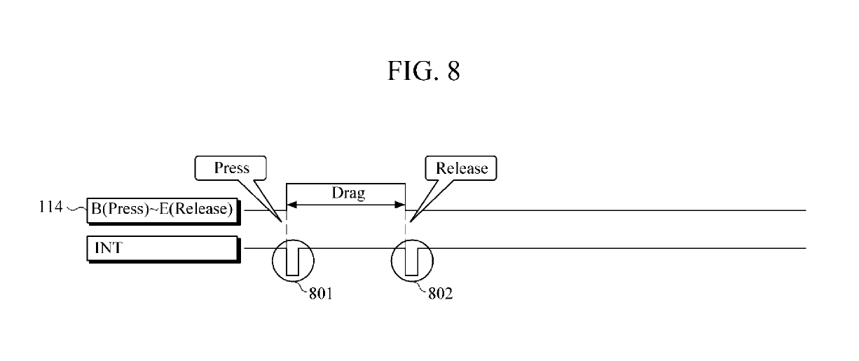

FIG. 8 is a timing diagram illustrating a user interrupt signal pulse of the touch sensing unit 120 in response to manipulation of a volume short key and a volume long key according to an exemplary embodiment of the present invention. The following description will be given with reference to FIG. 1 and FIG. 8.

After the touch sensing unit 120 transmits a user input interrupt signal to the data processor 150, the data processor 150 may distinguish a long key from a short key when performing volume up/down operation, using the following method.

At a touch start time, a user may provide a touch input on the touch sensor and begins performing a dragging motion or gesture with respect to the touch sensor B, the touch sensor C, the touch sensor D, and the touch sensor E of the second input area 114, and the touch sensing unit 120 may in response transmit a first interrupt signal 801 to the data processor 150. At a touch release time, the user removes his or her finger from the touch sensor at a location where the dragging motion is terminated, and the touch sensing unit 120 may in response transmit a second interrupt signal 802 to the data processor 150.

In order to distinguish a “Drag & Flick” gesture from a “Drag & Stop” gesture with respect to volume up and volume down operations, the data processor 150 may use a dragging time period, which may refer to a time period between the first interrupt signal 801 and the second interrupt signal 802 as shown in FIG. 8. The first interrupt signal 801 may correspond to a touch start time at which a touch input is provided on a touch screen and the touch input is dragged along the touch sensor B, the touch sensor C, the touch sensor D, and the touch sensor E of the second input area 114. The second interrupt signal 802 may correspond to a touch release time at which the user removes his or her finger from the touch sensor at a location where the dragging motion of the touch input is terminated. If it is determined that a dragging time period of a touch input is equal to or longer than a predetermined time period (e.g., 500 ms), the data processor 150 may recognize the touch input as a long key input. If it is determined that the dragging time period is shorter than the predetermined time period, the data processor 150 may recognize the touch input as a short key input.

In more detail, if the first interrupt signal 801 is received, the data processor 150 may access a second address of the register 122 of the touch sensing unit 120 to read a second register value from the second address. If the second interrupt signal 802 is received, the data processor 150 may detect a time period between the first interrupt signal 801 and the second interrupt signal 802, which may correspond to a dragging time period, and determines a corresponding control operation based on the dragging time period and the detected touch input and/or dragging motion corresponding to a gesture (e.g., volume up gesture, volume down gesture), which the second register value represents.

If the time period between the first interrupt signal 801 and the second interrupt signal 802 is determined to be shorter than a predetermined time period and the second register value corresponds to a volume up gesture, the data processor 150 may recognize the corresponding touch gesture as a volume up short key. Further, if the time period between the first interrupt signal 801 and the second interrupt signal 802 is shorter than the predetermined time period and the second register value corresponds to a volume down gesture, the data processor 150 may recognize the corresponding touch gesture as a volume down short key. If the time period between the first interrupt signal 801 and the second interrupt signal 802 is equal to or longer than the predetermined time period and the second register value corresponds to a volume up gesture, the data processor 150 may recognize the corresponding touch gesture as a volume up long key. If the time period between the first interrupt signal 801 and the second interrupt signal 802 is equal to or longer than the predetermined time period and the second register value corresponds to a volume down gesture, the data processor 150 may recognize the corresponding touch gesture as a volume down long key.

The above description relates to a situation where the touch input is received on the touch sensor E and dragged upwards to the touch sensor B, or when from the touch input is received on the touch sensor B and dragged downwards to the touch sensor E. When such touch inputs are sensed or detected, a gesture corresponding to a volume up or volume down operation may be recognized. However, if a sensed touch input or drag motion satisfies a predetermined threshold gesture rate for recognition, the corresponding touch input or drag motion may be recognized as a normal drag gesture. The gesture rate may be set to a ratio (e.g., 80%) of touch sensors that generate corresponding touch signals for the touch sensors that detects touch input that may be dragged thereon. Accordingly, a drag gesture from the touch sensor D to the touch sensor B may be recognized as a volume up gesture, and a drag gesture from the touch sensor C to the touch sensor E may be recognized as a volume down gesture. However, aspects of the invention are not limited thereto, such that one or more touch sensors may be operated independently without the use of a drag motion or gesture to perform one or more operations of the terminal 100. Further, various combinations of touch sensors may be operated simultaneously to perform one or more operations.

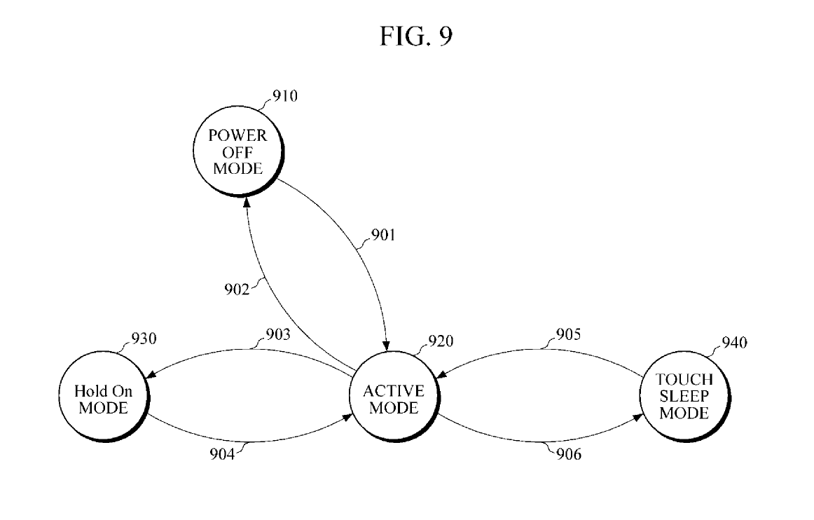

FIG. 9 illustrates a state model of a mobile terminal 100 according to an exemplary embodiment of the present invention.

The operation modes of the mobile terminal 100 include a power off mode 910, an active mode 920, a hold on mode, and a touch sleep mode 940.

Referring to FIG. 1 and FIG. 9, the power off mode 910 is a power off state in which no power may be supplied to the mobile terminal 100. In the power off mode 910, the touch sensing unit 120 is in a turned on state, and the touch sensing unit 120 may activate the second input area 114, which may be a power key input area. If a power on gesture is sensed in the power off mode 910, the power on mode may be converted into the active mode 920, as indicated by an arrow 901 of FIG. 9. If a power off gesture is sensed in the active mode 920, the active mode 920 may be converted into the power off mode 910, as indicated by an arrow 902.

The active mode 920, the hold on mode 930, and the touch sleep mode 940 may refer to modes of the mobile terminal 100 that may be transitioned into when the mobile terminal 100 is in a power on state.

The active mode 920 may refer to a state in which power is supplied to the mobile terminal 100, both the touch panel 110 and the touch screen (not shown) are activated so that various operations of the mobile terminal 110 may be performed to operate normally. For example, in the active mode 920, user inputs can be received, and applications can be executed according to the user inputs.

In the hold on mode 930, some operations of the mobile terminal 100 may be deactivated since no power may be supplied to the corresponding modules of the mobile terminal 100. In the hold on mode 930, the first input area 112 of the touch panel 110 may be activated and the second input area 114 may be deactivated so that user touch inputs may be sensed in the first input area 112. If a hold off gesture (e.g., Short Key Touch & Drag) is sensed in the hold on mode 930, the hold on mode 930 may be converted into the active mode 920, as indicated by an arrow 904.

The touch sleep mode 940 may refer to a mode into which the touch sensing unit 120 may enter, as indicated by an arrow 906, when no user touch input on the touch panel 110 is sensed for a predetermined time period in the active mode 920. More specifically, when the mobile terminal 100 is in the touch sleep mode 940, the state of the mobile terminal 100 may be similar or the same as when the mobile terminal 100 is in the active mode, except for the state of the touch sensing unit 120. The touch sleep mode 940 may refer to a mode for reducing power consumption of the touch sensing unit 120 when no touch input is sensed for a predetermined time period in the active mode 920. When a touch gesture of touching the touch panel 110 is sensed in the touch sleep mode 940, the touch sleep mode 940 may be converted into the active mode 920, as indicated by an arrow 905.

The data processor 150 may operate according to the power off mode 910, the active mode 920, and the hold on mode 930. When the mobile terminal 100 enters a mode, the data processor 150 may set a register value corresponding to the entered mode as a first register value and write the first register value in the first address of the register 212 of the touch sensing unit 120. For example, when the mobile terminal 100 enters the power off mode 910, the data processor 150 may write a value 0xF0 as a first register value in the first address of the register 212 of the touch sensing unit 120, and when the mobile terminal 100 enters the active mode 920, the data processor 150 may write a value 0xF8 as state information in the first address of the register 212.

The touch sensing unit 120 may control the touch panel 110 according to the first register value. In the power off mode 910 and the hold on mode 930, only the first input area 112 of the touch panel 110 may be activated. In the active mode 920, both the first input area 112 and the second input area 114 of the touch panel 110 may be activated. Also, in the touch sleep mode 940, both the first input area 112 and the second input area 114 may be activated while controlling the touch panel 110 so that the touch panel 110 may consume less power than in the active mode 920.

When a user's unintended touch key is inputted and if another touch input is not sensed for a predetermined time period (e.g., 5 seconds), although the mode of the mobile terminal 100 may have converted into an active mode 920, the mobile terminal 100 may return to its previous touch sleep mode 940. For example, when a touch input is sensed while the mobile terminal 100 is in the touch sleep mode 940, the mobile terminal 100 may enter the active mode 920. If another touch input is not sensed after the initial touch input for a predetermined period of time, the mobile terminal 100 may return to the touch sleep mode 940. The operation may be applied in the same manner to when the mobile terminal 100 is in the hold on mode 930 and the power off mode 910.

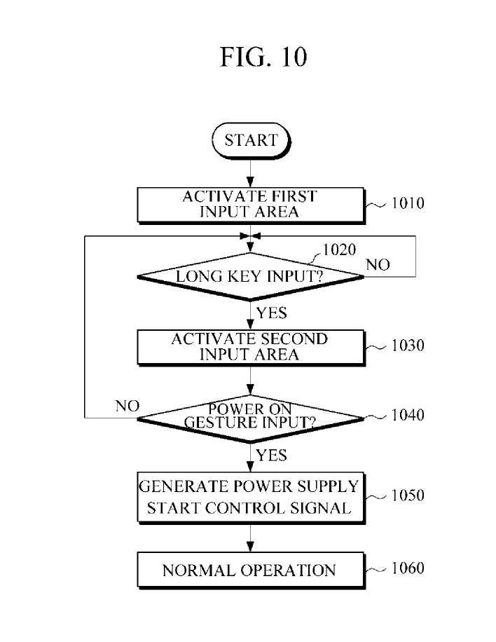

FIG. 10 is a flowchart illustrating a method for performing a power control operation according to an exemplary embodiment of the present invention. The following description will be given with reference to FIG. 1 and FIG. 10.

When the mobile terminal 100 is in the power off state, the first input area 112 of the touch panel 110 is activated (1010). Also, the second input area 114 may not be activated.

If a long key touch input is detected on the first input area 112 to generate a touch signal that may be maintained for a first time period (1020), the touch sensing unit 120 activates the second input area 114 (1030).

If a power on gesture is detected or sensed on the second input area 114, more specifically, if a touch input is sensed on the second input area 114 and the touch input is dragged across in a first direction (1040), the touch sensing unit 120 may generate a power supply start control signal for supplying power to the mobile terminal 100 (1050). Further, the power controller 130 supplies power to the mobile terminal 100 according to the power supply start control signal, so that the mobile terminal 100 operates normally (1060).

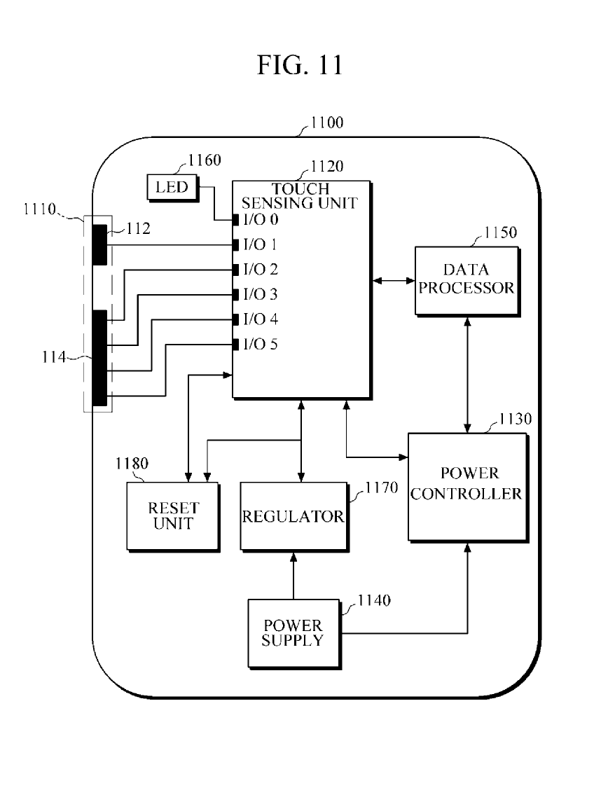

FIG. 11 is a diagram illustrating a configuration of a mobile terminal 1100 according to an exemplary embodiment of the present invention.

Referring to FIG. 11, the mobile terminal 1100 includes a touch panel 1110, a touch sensing unit 1120, a power controller 1130, a power supply 1140, a data processor 1150, a LED 1160, a regulator 1170, and a reset unit 1180. The operation of the touch panel 1110, the touch sensing unit 1120, the power controller 1130, the power supply 1140, the data processor 1150, and the LED 1160 may be similar or the same as that of the touch panel 110, the touch sensing unit 120, the power controller 130, the power supply 140, the data processor 150, and the LED 160 of the mobile terminal 100 illustrated in FIG. 1. The mobile terminal 1100 further includes the regulator 1170 and the reset unit 1180, compared to the mobile terminal 100 of FIG. 1.

The power supply 1140 supplies power to the touch sensing unit 1120 through the regulator 1170. The regulator 1170 may be a Low Drop-Out regulator or other comparable regulator. The regulator 1170 may adjust the output of the power supply 1140 to supply constant power to the touch sensing unit 1120.

The mobile terminal 1100 may control its operation and power based on a touch input using the touch panel 1100 and the touch sensing unit 1120. Accordingly, the state of the touch sensing unit 1120 may be stabilized such that a wrong operation may not occur in the touch sensing unit 1120.

The touch sensing unit 1120 may be connected to the power supply 1140 so that the touch sensing unit 1120 may be in a turned-on state regardless of the state of the rest of the component units in mobile terminal 1100. If the power supply 1140 is connected to the touch sensing unit 1120, leakage current higher than 100 microampere (uA) may be generated due, at least in part, to the electrical characteristics of the internal circuit of the touch sensing unit 1100. Furthermore, when the mobile terminal 1100 performs wireless communication with a base station in a region with a weak electric field, the mobile terminal 1100 may have power or current fluctuations. For example, current fluctuation ranging from several hundreds of milliampere (mA) to 1 ampere (A) or higher may occur according to a use condition of the mobile terminal 1100. If a large amount of current is consumed through the power supply 1140, a ripple phenomenon where battery power fluctuates may appear so that the touch sensing unit 1120 reacts sensitive to input power, resulting in a wrong operation. The regulator 1170 may be used to supply constant power to the touch sensing unit 1120 to reduce leakage of current from the power supply 1140, and to adjust, when the power supply 1140 provides fluctuating power. Fluctuating power may be provided due, at least in part, to changes in current consumption according to a use condition of the mobile terminal 110. More specifically, when ripples are generated in the output of the power supply 1140 based on the changes in the current consumption, the output of the power supply 1140 may provide stabilized power to the touch sensing unit 1120 through the use of the regulator 1170, thereby stabilizing the operation of the touch sensing unit 120.

Further, since the regulator 1170 may be installed outside the touch sensing unit 1120, it may be possible to separate the operation of the regulator 1170 from the operation of the touch sensing unit 1120. Accordingly, since the entire internal circuit of the touch sensing unit 1120 may not be activated to operate the regulator 1170, it may be possible to reduce current consumption of the mobile terminal 1100.

The power supply 1140 may be a battery that is removable by a user. When a user attaches the power supply 1140 to the mobile terminal 110 or removes the power supply 1140 from the mobile terminal 1100, the output of the regulator 1170 may become unstable and the internal circuit of the touch sensing unit 1120 may operate wrongly.

The reset unit 1180 may reset the touch sensing unit 1120 when a predetermined time period elapses after an output signal from the regulator 1170 is outputted to the touch sensing unit 1120. Accordingly, the operation of the touch sensing unit 1120 may be stabilized so that the touch sensing unit 1120 can stably process a touch gesture signal generated in response to a touch gesture sensed on the touch panel 1110, which may reduce the likelihood of the mobile terminal 1100 from operating wrongly when the power source 1140 is attached or removed from the mobile terminal 1100.

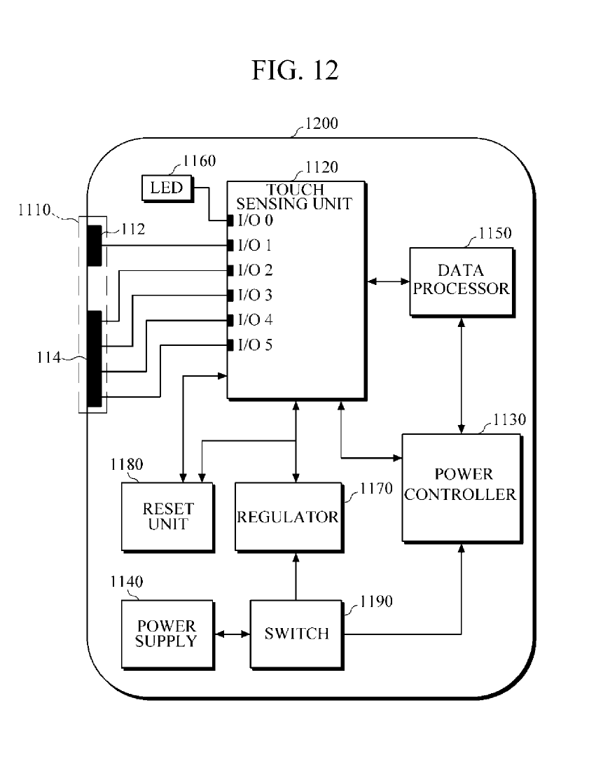

FIG. 12 is a diagram illustrating a configuration of a mobile terminal 1200 according to an exemplary embodiment of the present invention.

The mobile terminal 1200 illustrated in FIG. 12 further includes a switch 1190 compared to the mobile terminal 1100 of FIG. 11.

When the mobile terminal 1200 is in a powered off state, power may be supplied to the regulator 1170 and the touch sensing unit 1120 but not to the other components. The switch 1190 may be selectively added to the mobile terminal 1200.

The switch 1190 may be disposed between the regulator 1170 and the power supply 1140 to control power that is supplied to the regulator 1170. If the switch 1190 is turned on, power may be supplied to the regulator 1170, and if the switch 1190 is turned off, power may not be supplied to the regulator 1170. Since current may no longer leak noticeable amount of current to the regulator 1170 when the switch 1190 is in the turned-off state, power consumption may be reduced. When the switch 1190 is in the turned-off state, no power may be supplied to some or all of the internal components of the mobile terminal 110, including the regulator 1170 and the touch sensing unit 1120. Accordingly, when the switch 1190 is in the turned-off state, both the first input area 112 and the second input area 114 of the touch panel 1110 may be deactivated so that no touch input is processed.

The switch 1190 may be a button type switch or a touch type switch that may s receive a user input with respect to the mobile terminal 1200. However, aspects of the invention are not limited thereto, such that the switch 1190 may be a flip type switch, a dial, and other comparable mechanisms.

If the switch 1190 is a touch type switch, the switch 1190 may include a single touch sensor (not shown) to sense a single touch input, and a switching module (not shown) to supply power to the regulator 1170 or to prevent power from being supplied to the regulator 1170 according to the received touch input. If a touch input received on the single touch sensor is sensed longer than a predetermined time period when the switch 1190 is in the turned-off state, the touch input may be recognized as an input for turning on the switch 1190 to turn on the switching module. If the touch input is sensed shorter than the predetermined time period, the touch input may be ignored. Likewise, if a touch input sensed by the single touch sensor is maintained longer than the predetermined time period when the switch 1190 is in the turned-on state, the touch input may be recognized as a touch input for turning off the switch 1190.

The regulator 1170 may consume power even when the mobile terminal 1200 may be in the powered off state. Accordingly, when the mobile terminal 100 is powered off for a long time, by turning off the switch 1190 of the mobile terminal 100, power consumption through the regulator 1170 can be prevented or reduced.

To convert the powered off state of the mobile terminal 100 into the powered on state in which the mobile terminal 100 may operates normally, the switch 1190 may be turned on to sequentially supply power to the regulator 1170 and the touch sensing unit 1120. If power is supplied to the touch sensing unit 1120, the first input area 112 may activated, and when a long key touch input is detected on the first input area 112, and a dragging motion of the touch input is detected on the second input area 114, the mobile terminal 1200 may enter the powered on state in which the mobile terminal 1100 may operate normally.

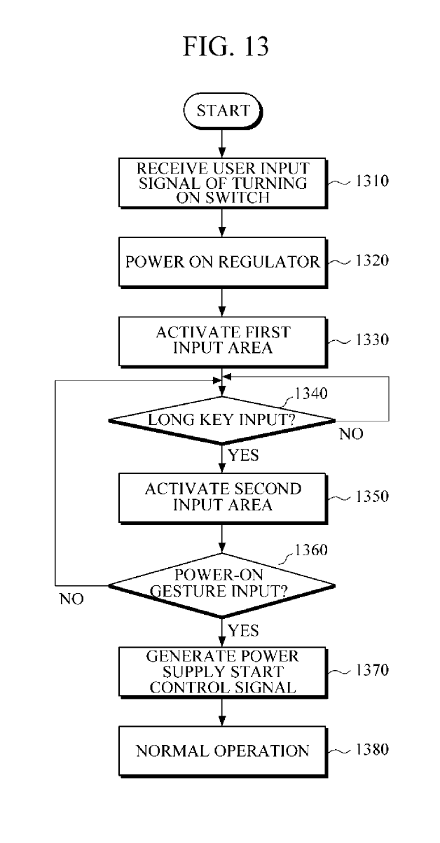

FIG. 13 is a flowchart illustrating a method for performing a power control operation according to an exemplary embodiment of the present invention.

Referring to FIG. 12 and FIG. 13, the mobile terminal 1200 in a powered off state, with the switch 1190 in a turned-off state, may be converted into the power on state will be described below. If the switch 1190 is in the turned-off state, no power may be supplied to the internal components of the mobile terminal 1200.

If a user input signal for turning on the switch 1190 is received (1310), the switch 1190 may be turned on, and the power from the power supply 1140 is supplied to the regulator 1170 (1320). Accordingly, the touch sensing unit 1120 is turned on so that the first input area 112 is activated (1330).

If a long touch input is detected in the first input area 112 and maintained thereon for a first time period to generate a corresponding touch signal that is maintained for the first time period (1340), the touch sensing unit 1120 activates the second input area 114 (1350).

If a touch signal corresponding to a touch input that may be dragged across the second input area 114 in a first direction, which may correspond to a power on gesture, is received when the second input area 114 is in the activated state (1360), the touch sensing unit 1120 generates a power supply start control signal (1370) to direct the power controller 1130 to supply power to the mobile terminal 1200, so that the mobile terminal 1200 operates normally (1380).

According to exemplary embodiments of the present invention, since a touch-based power key and volume keys, instead of mechanical switches, can be configured on the outer surface of a mobile terminal, it may be possible to improve a design of a mobile terminal and provide more operation options.

Also, by using a regulator to supply power to a touch sensing unit, it may be possible to reduce power consumption of a mobile terminal and stabilize the operation of the touch sensing unit.

Exemplary embodiments of the present invention can be implemented as to computer readable codes in a non-transient computer readable record medium. The non-transient computer readable record medium includes all types of record media in which computer readable data are stored. Examples of the non-transient computer readable record medium include a Read Only Memory (ROM), a Random Access Memory (RAM), a Compact Disc ROM (CD-ROM), a magnetic tape, a floppy disk, and an optical data storage. In addition, the non-transient computer readable record medium may be distributed to computer systems over a network, in which computer readable codes may be stored and executed in a distributed manner.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for controlling an operation of a mobile terminal using a touch, comprising:
detecting a first touch input in a first input area;
determining whether to activate a second input area based on the first touch input;
detecting a touch gesture in the second input area if the second input area is activated;
determining a state of the mobile terminal; and
determining a control operation corresponding to the touch gesture with respect to the state of the mobile terminal,
wherein at least one of the first input area and the second input area is disposed at a side of a body of the mobile terminal.

2. The method of claim 1, wherein the state of the mobile terminal comprises at least one of an active mode, a power off mode, a hold on mode, and a touch sleep mode.

3. The method of claim 1, wherein the second input area comprises a plurality of touch sensors.

4. The method of claim 1, wherein the control operation comprises at least one of a power control operation, a hold control operation, and a volume control operation.

5. The method of claim 1, wherein the determination of whether the first touch input activates the second input area is based on a length of time the touch input is placed on the first input area.

6. The method of claim 1, wherein control operation is based on at least one of a direction of the touch gesture, a time duration associated with the touch gesture, a gesture rate, and a hold time on the second input area after the touch gesture is terminated.

7. The method of claim 1, wherein the touch gesture comprises providing a second touch input and dragging the second touch input through the second input area.

8. The method of claim 1, wherein the control operation is performed by controlling a power supply of at least one component of the mobile terminal.

9. The method of claim 1, wherein the first touch input is received when the mobile terminal is in a powered off state.

10. A mobile terminal to control an operation using a touch, comprising:
a first input area to detect a first touch input;
a second input area to detect a touch gesture; and
a touch sensing unit to detect whether to activate the second input area based on the first touch input, to determine a state of the mobile terminal, and to determine a control operation corresponding to the touch gesture with respect to the state of the mobile terminal,
wherein at least one of the first input area and the second input area is disposed on a side of a body of the mobile terminal.

11. The mobile terminal of claim 10, wherein the state of the mobile terminal comprises at least one of an active mode, a power off mode, a hold on mode, and a touch sleep mode.

12. The mobile terminal of claim 10, wherein the second input area comprises a plurality of touch sensors.

13. The mobile terminal of claim 10, wherein the control operation comprises at least one of a power control operation, a hold control operation, and a volume control operation.

14. The mobile terminal of claim 10, wherein the determination of whether the first touch input activates the second input area is based on a length of time the touch input is placed on the first input area.

15. The mobile terminal of claim 10, wherein control operation is based on at least one of a direction of the touch gesture, a time duration of touch input, a gesture rate, and a hold time on the second input area after the touch gesture is terminated.

16. The mobile terminal of claim 10, wherein the touch gesture comprises providing a second touch input and dragging the second touch input through the second input area.

17. The mobile terminal of claim 10, further comprising a power controller to control a power supply of at least one component of the mobile terminal with respect to the control operation.

18. The mobile terminal of claim 17, further comprising a regulator to supply constant power to the touch sensing unit, and to adjust fluctuation in power provided to the touch sensing unit.

19. The mobile terminal of claim 10, wherein the first touch input is received when the mobile terminal is in a powered off state.

20. The mobile terminal of claim 18, further comprising:
a reset unit to reset the touch sensing unit when a reference time period elapses after the regulator supplies power to the touch sensing unit.

21. The mobile terminal of claim 18, further comprising:
a switch to control supply of power to the regulator.

22. The mobile terminal of claim 21, wherein, if the switch is turned from an off state to an on state, the power is supplied to the regulator and the touch sensing unit.

23. A method for controlling an operation of a mobile terminal using a touch, comprising:
detecting a touch gesture in an input area disposed at a side of a body of the mobile terminal;
determining a state of the mobile terminal; and
determining a control operation corresponding to the touch gesture with respect to the state of the mobile terminal.
